(19) United States
(12) Patent Application Publication
(10) Pub. No.: US 2002/0056741 A1
(43) Pub. Date: May 16, 2002

(54) Application of wire bonding technology on wafer bump, wafer level chip scale package structure and the method of manufacturing the same

(76) Inventors: Wen Lo Shieh, Kaohsiung City (TW); Huang Fu-Yu, Kaohsiung City (TW); Tu Feng Chang, Kaohsiung City (TW); Yung-Cheng Chuang, Kaohsiung City (TW)

Correspondence Address: Wen Lo SHIEH, PO Box 82-144, TAIPEI, TW

(21) Appl. No.: 09/834,629

(22) Filed: Apr. 16, 2001

(30) Foreign Application Priority Data
Nov. 16, 2000 (TW) 089124495

(51) Int. Cl. B23K 1/06; B23K 5/20; B21D 39/00

(52) U.S. Cl. 228/180.5; 228/110.1; 228/159; 228/246

(57) ABSTRACT

A wire bonding technique applied to wafer bump and wafer level chip size package structure and the method of manufacturing thereof comprising under no repassivation layer and without an under bump metallurgy layer, direct forming metal bump on a metal pad of a wafer surface, ball bump, method being employed to form metal bump, and wire bonding of ultrasonic vibration being used to join a suitable metal wire on the metal pad, next pulling off the metal wire and leaving the metal bump, the height of the metal bump is controlled by the parameters of the type, diameter and wire bonding of the metal wire; planarizing the metal bump of all wire bonding to an appropriate height using metallurgical tools; implanting solder bump by means of implant ball or solder printing technology on the metal bump, and an under bump metallurgy layer being formed on the top face of the metal block by means of metal deposition method in case an unfavorable intermetallic compound is formed between the metal (used for the metal bump) and the solder ball, and then proceeded to implantation.

### BACKGROUND OF THE INVENTION

(a) Technical Field of the Invention

The present invention relates to application of wire bonding technology on wafer bump, and wafer level chip scale package structure, and the method of manufacturing the same, and in particular, in the application on wafer bump, without the under bump metallurgy layer, and forming metal bump on wafer metal pad or the metal pad of the redistribution layer.

(b) Description of the Prior Art

Recently, portable electronic products have become very common and popular in the electronic consumer market. This is due to the fast development of “lightweight, thin, short and small size” chip scale package (CSP) of the semiconductor technology. Recently, more and more integrated circuit (IC) package tests are following the development of Wafer Level Package (WLP). The so-called “Wafer Level Chip Scale Package” refers to the processes of completion of package prior to the dicing of the wafer.

Conventionally, a method of wafer level chip scale package is generally done by, on a passivation layer of the wafer, coating a layer of polymeric material passivation. Next, by employing the method of sputtering, photolithography technique, an under bump metallurgy layer or I/O pad redistribution layer is formed. By employing the electroplate bump technique, a metal post is formed on the under bump metallurgy layer or a redistribution pad, and on the top surface of the metal post, an under bump metallurgy layer is formed. Next, a solder ball is formed thereon.

In another method of wafer level chip scale package, a photo-sensitive type of polyimide layer or other suitable polymeric material layer 2′ is coated onto the protective layer 11′ of the wafer 1′, and next, a photolithography technique or laser drilling technique is used to open the position of the polymeric material layer 2′ relative to the metal pad 10′. Next, at the opening 21′, a metal post 3′ is formed and a solder ball 4′ is implanted (as shown in FIGS. 1a to 1e).

### SUMMARY OF THE INVENTION

Accordingly, it is an object of the present invention to provide the application of wire bonding technology on wafer bumps, wafer level chip scale package structure and the method of manufacturing the same, wherein, without an under bump metallurgy (UBM) layer, a metal bump or metal post is manufactured by directly employing the wire bonding technology, and therefore the costs for material and manufacturing process are greatly reduced.

Yet another object of the present invention is to provide application of wire bonding technology on wafer bumps, wafer level chip scale package structure and the method of manufacturing the same, wherein on the metal pad of the wafer redistribution layer or on the metal pad of the wafer, there first forms a metal post, and next, uncured polymeric material is used to cover the metal post and after the polymeric material is cured, the solder bump is appropriately grinded and implanted on the top surface of the metal post.

An aspect of the present invention is to provide a wire bonding technique applied to wafer bump and wafer level chip scale package structure and the method of manufacturing thereof comprising under no repassivation layer and without an under bump metallurgy layer, directly forming a metal bump on a metal pad of a wafer surface, a bonding bump, a method being employed to form a metal bump, and wire bonding of ultrasonic vibration being used to join a suitable metal wire on the metal pad, next, pulling off the metal wire and leaving the metal bump. The height of the metal bump is controlled by the type, diameter and bonding parameter of the metal wire; planarizing the metal bump of all wire bonding to an appropriate height using metallurgical tools; implanting solder bump by means of an implant ball or solder printing technology on the metal bump, and an under bump metallurgy layer being formed on the top face of the metal block by means of metal deposition method in case an unfavorable intermetallic compound is formed between the metal (used for the metal bump) and the solder ball, and then proceeded to implantation.

A further aspect of the present invention is to provide a wire bonding technique applied to wafer bump and wafer level chip scale package structure and the method of manufacturing thereof comprising the steps of: under no repassivation layer and without an under bump metallurgy layer, directly forming a metal post on a metal pad of a wafer surface, a bonding bump, a method being employed to form a metal post, and wire bonding of ultrasonic vibration being used to join a suitable metal wire on the metal pad, next pulling off the metal wire and leaving the metal post, wherein the height of the metal post is controlled by the type, diameter and bonding parameter of the metal wire; covering the metal post and the wafer protective layer with a layer of uncured polymeric layer and then proceeding to curing. The polymeric materials have the following properties: low temperature coefficient of expansion (TCE), low Young's Modulus, low water absorption, low moisture permeability, high adhesion, low dielectric constant, low conductivity, and the method of packaging including molding, dispensing, spin coating, spray, screen printing or vacuum printing, grinding or chemical-mechanical polishing of the top surface of the polymeric materials to expose the metal post, implanting solder ball bumps by implant balls or solder printing on the metal post, and an under bump metallurgy layer being formed on the top face of the metal block by means of metal deposition method in case an unfavorable intermetallic compound is formed between the metal (used for the metal bump) and the solder ball, and then proceeded to implantation.

### BRIEF DESCRIPTION OF THE DRAWINGS

FIGS. 1a to 1e show the structure of a metal post of conventional wafer level chip scale package structure.

FIG. 2 is a schematic view showing the metal bump of the wire bonding method of the first preferred embodiment of the present invention.

FIG. 3 is a schematic view showing the leveling metal bump of the wire bonding method of the first preferred embodiment of the present invention.

FIG. 4a is a schematic view of the implant solder ball bump of the wafer metal bump of the wire bonding method of the first preferred embodiment of the present invention.

FIG. 4b is a schematic view showing the addition of under bump metallurgy layer and then implant with the solder ball bump of the wire bonding method of the first preferred embodiment of the present invention.

FIG. 5 is a schematic view showing the manufacturing of the metal bump on wafer level chip scale package with redistribution layer of a second preferred embodiment of the present invention.

FIG. 6 is a schematic view showing the metal post of the wire bonding method of the third preferred embodiment of the present invention.

FIG. 7 is a schematic view showing the covered polymeric material layer in accordance with the third preferred embodiment of the present invention.

FIG. 8 is a schematic view showing the grinding of the top surface of the polymeric material layer of the third preferred embodiment of the present invention.

FIG. 9a is a schematic view of the implant solder ball bump of the wafer metal post of the wire bonding method of the third preferred embodiment of the present invention.

FIG. 9b is a schematic view showing the addition of under bump metal post layer which is then implanted with the solder ball bump of the wire bonding method of the third preferred embodiment of the present invention.

FIG. 10 is a schematic view showing the manufacturing of metal post on the redistribution layer of the chip size package of the fourth preferred embodiment of the present invention.

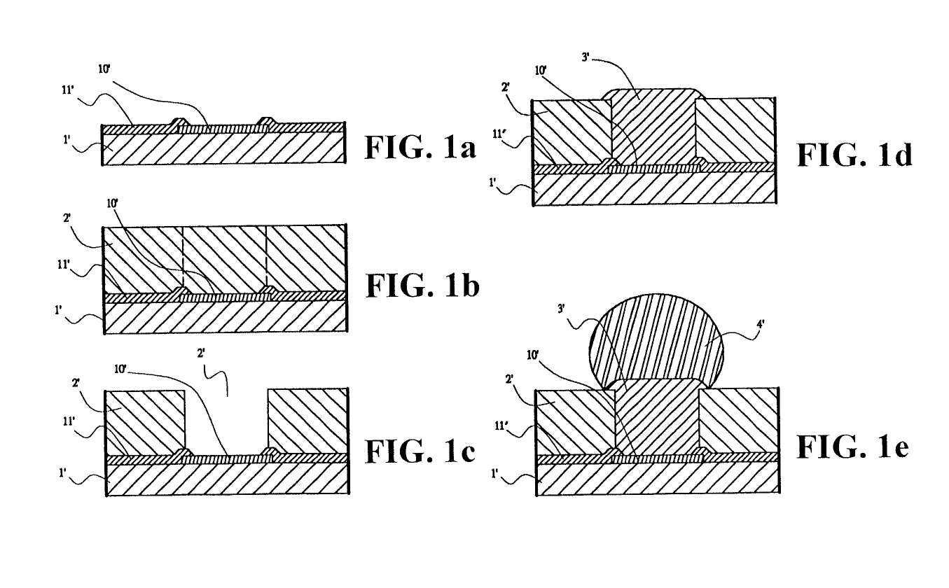

### DETAILED DESCRIPTION OF THE PREFERRED EMBODIMENT

First Preferred Embodiment

In accordance with the present invention, the application of wire bonding technology on the wafer bump and wafer level chip scale package structure, and the method of manufacturing thereof comprise the following steps:

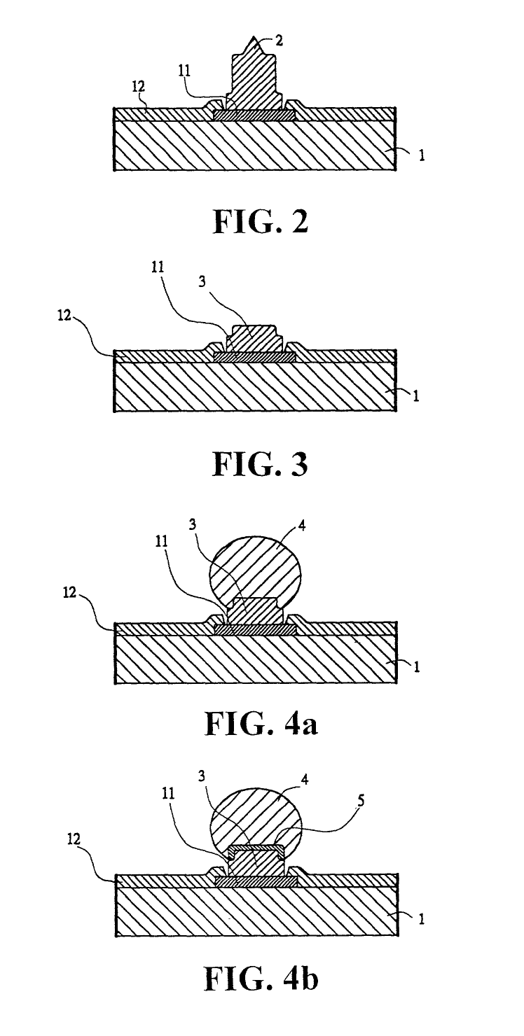

(1) Under no repassivation layer and without an under bump metallurgy layer, a metal bonding bump 3 is directly formed on a metal pad 11 of a wafer surface. The method of forming the metal bonding bump 3 is by a wire bonding method (for instance, bell bump, pull off bump, stud bump). As shown in FIG. 2, conventional ultrasonic with vibration wire bonding devices are employed by first joining appropriate metal wires 21 (for example Au, Al, Cu, Sn—Pb, Sn—Ag) on the metal pad 11, and the bonding capillary is moved upward to pull off or the metal wire 2 is cut off so that the metal bonding bump 3 of the wire bonding remains. Next, the height of the metal bump 3 is controlled by the the type, diameter and wire bonding parameters of the metal wire which are normally within 100 micro meters;

(2) Planarizing the metal bump 3 of all wire bonding to an appropriate height using leveling tools (referring to FIG. 3) for subsequent implanting;

(3) Implanting solder bumps 4 by means of implant balls or solder printing technology on the metal bump 3 (referring to FIG. 4a), and having an under bump metallurgy layer formed on the top face of the metal bump 3 by means of metal deposition method in case an unfavorable intermetallic compound is formed between the metal (used for the metal bump) and the solder ball. Implantation then proceeds. As shown in FIG. 4b, electroplating or chemical electroless plating is employed. The top face of the metal bump 3 is formed with an under bump metallurgy layer.

Second Preferred Embodiment

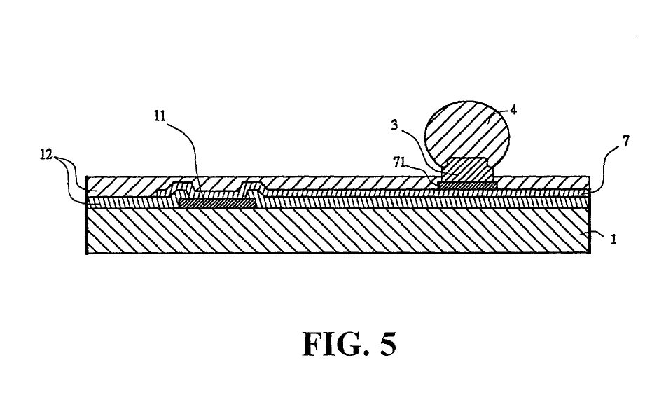

As shown in FIG. 5, the metal bonding bump 3 is first prepared on the metal pad 71 having a redistribution layer 7 of the wafer 1, and the method of forming the metal bonding bump 3 and the implant solder ball 4 are similar to that of the first preferred embodiment. The steps are as follows:

(1) under no repassivation layer and without an under bump metallurgy layer, a metal bonding bump 3 is directly formed on a metal pad 71 of a redistribution layer. The method of forming the metal bonding bump 3 is by wire bonding method by first joining appropriate metal wires 21 on the metal pad 71, and the bonding capillary is moved upward to pull off or the metal wire 2 is cut off so that the metal bonding bump 3 of the wire bonding is left. Next, the height of the metal bump 3 is controlled by the type, diameter and wire bonding parameters of the metal wire. These are normally:;

(b) planarizing the metal bump 3 of all wire bonding to an appropriate height using metallurgical tools for subsequent implanting;

(c) implanting solder bump 4 by means of implant ball or solder printing technology on the metal bump 3, the metal bump consists of Al, Ni, Au, or Sn—Pb alloy, Sn—Ag alloy, and an under bump metallurgy layer being formed on the top face of the metal bump 3 by means of metal deposition method in case an unfavorable intermetallic compound is formed between the metal (used for the metal bump) and the solder ball, and then implantation proceeds.

Third Preferred Embodiment

In accordance with the present invention, a wire bonding technique is applied to wafer bump and wafer level chip size package structure and the method of manufacturing thereof. The method comprises the following steps:

(a) under no repassivation layer and without an under bump metallurgy layer, direct forming metal post 61 on a metal pad 11 of a wafer 1 surface by the method of a bell bump, pull off bump method, which is employed to form a metal post as shown in FIG. 3a, wire bonding of ultrasonic vibration used to join a suitable metal wire on the metal pad 11, next pulling off the metal wire 6 (Au, Al, Cu, Sn—Pb, Sn—Ag material) and leaving the metal post 61, the height of the metal post 61 is controlled by the type, diameter and wire bonding parameters of the metal wire (as shown in FIG. 6), generally, within 250 micrometer;

(b) covering the metal post 61 and the wafer passivation layer 12 with a layer of uncured polymeric layer 8 and then proceeding to curing (as shown in FIG. 7); wherein the polymeric material has the following properties: low temperature coefficient of expansion CTCE), low Young's Modulus, low water absorption, low moisture permeability, high adhesion, low dielectric constant, low conductivity, and the method of packaging including molding, dispensing, spin coating, spray, screen printing or vacuum printing,

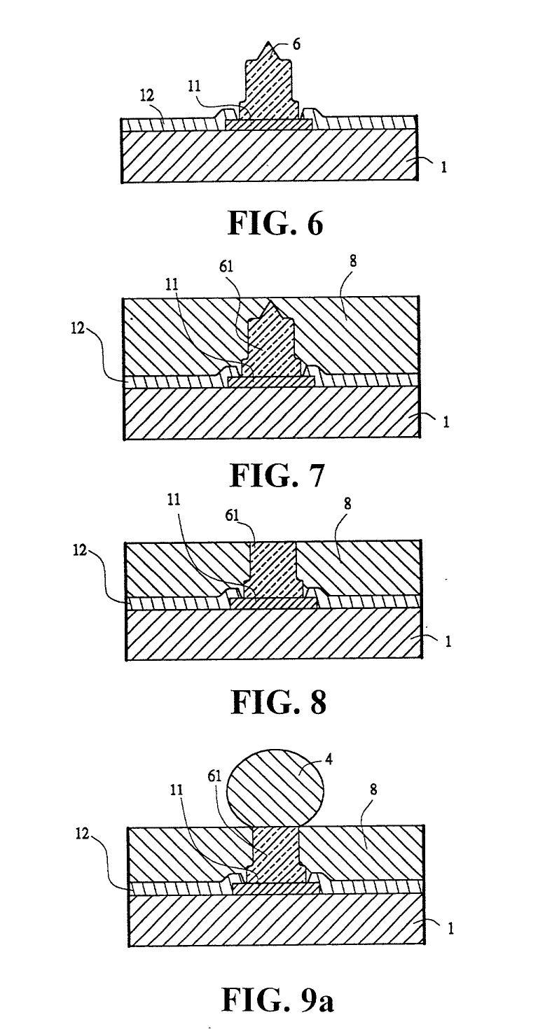

(c) grinding or chemical-mechanical polishing of the top surface of the polymeric material 8 to expose the metal post 61 (as shown in FIG. 8),

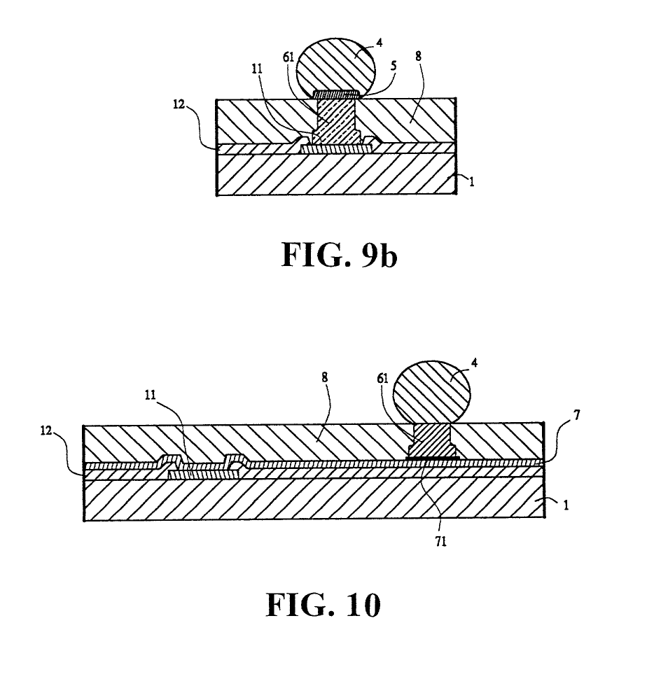

(d) implanting the solder ball bump 4 by implant ball or solder printing on the metal post 61 (as shown in FIG. 9a), which consists of Al, Ni, Au, Sn—Pb, Sn—Ag material, and an under bump metallurgy layer 5 being formed on the top face of the metal bump by means of metal deposition method in case an unfavorable intermetallic compound is formed between the metal (used for the metal bump) and the solder ball, and then proceeded to implantation (as shown in FIG. 9b). The metal deposition method includes electroplating or chemical electroless plating.

The Fourth Preferred Embodiment

Referring to FIG. 10, there is shown a wire bonding applied to wafer bump and wafer level chip scale package structure, and the method of manufacturing thereof. First, on the metal pad 71 of the redistribution layer 7 of the wafer 1, a metal post 61 is formed. The method of forming the metal post 61 and the covering steps for polymeric material layer 8, the grinding process, and the process of implanting solder bump 4 are similar to that of the third preferred embodiment. The steps are as follows:

(a) the method of forming the metal post 61 is by the method of wire bonding. On a metal pad 71, having a redistribution layer 7, appropriate metal wire 6 is joined thereon. Next, the soldering needle is moved upward to pull off or to break the metal wire 6 so that the metal post 61 of the wire bonding in the bump is obtained. The height of the metal post 61 is controlled by the type sized of metal wire 61 and the wire bonding parameters;

(b) after the metal post 61 has been prepared, a layer of uncured polymeric material layer 8 is used to cover the redistribution layer 7 of the wafer 1 and the metal post 61. After it has evenly covered the surface of the wafer 1, the curing process then proceeds;

(c) the top surface of the polymeric material layer 8 is ground so that the flat surface of the metal post 61 is exposed; and

(d) next, the metal post 61 is implanted into the solder bump 4. If the metal used for the metal post 61 is easily formed into an unfavorable intermetallic compound with the solder bump 4, a metal deposition method is carried out by forming an under bump metallurgy layer 5 on the top surface of the metal post 61, and after that implantation proceeds.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiments, but only by the scope of the appended claims.

We claim:

1. A wire bonding technique applied to wafer bump and wafer level chip scale package structure and the method of manufacturing thereof comprising
(a) under no repassivation layer and without an under bump metallurgy layer, directly forming metal bumps on a metal pad of a wafer surface, the bell bump or pull off method being employed to form metal bumps, and wire bonding of ultrasonic vibration being used to join a suitable metal wire on the metal pad, next pulling off the metal wire and leaving the metal bump, the height of the metal bump is controlled by the type, diameter and bonding parameters of the metal wire;
(a) planarizing the metal bump of all wire bonding to an appropriate height using leveling tools;
(c) implanting solder bump by means of implant ball or solder printing technology on the metal bump, and an under bump metallurgy layer being formed on the top face of the metal block by means of metal deposition method in case an unfavorable intermetallic compound is formed between the metal (used for the metal bump) and the solder ball, and then proceeded to implantation.

2. A wire bonding technique applied to wafer bump and wafer level chip scale package structure and the method of manufacturing thereof as set forth in claim 1, wherein the metal bump formed form metal lead sire of step (a) is joined onto the metal pad of the wafer redistribution layer, and then is proceeded to steps (b) and (c).

3. A wire bonding technique is applied to wafer bump and wafer level chip scale package structure and the method of manufacturing thereof comprising
(a) under no repassivation layer and without an under bump metallurgy layer, direct forming metal post on a metal pad of a wafer surface, bell bump or pull off method being employed to form metal post, and wire bonding of ultrasonic vibration being used to join a suitable metal wire on the metal pad, next pulling off the metal wire and leaving the metal post, the height of the metal post is controlled by the type, diameter and bonding parameters of the metal wire;
(b) covering the metal post and the wafer protective layer with a layer of uncured polymeric layer and then proceeding to curing; wherein the high polymeric materials has the following properties: low temperature coefficient of expansion (TCE), low Young's Modulus, low water absorption, low moisture permeability, high adhesion, low di-electric constant, low conductivity, and the method of packaging including molding, dispensing, spin coating, spray, screen printing or vacuum printing,
(c) grinding or chemical-mechanical polishing of the top surface of the high polymeric materials to expose the metal post,
(d) implanting solder ball bump by implant ball or solder printing on the metal post, and an under bump metallurgy layer being formed on the top face of the metal block by means of metal deposition method in case an unfavorable intermetallic compound is formed between the metal (used for the metal bump) and the solder ball, and then proceeded to implantation.

4. A wire bonding technique applied to wafer bump and wafer level chip scale package structure and the method of manufacturing thereof as set forth in claim 3, wherein the metal bump formed form metal lead sire of step (a) is joined onto the metal pad of the wafer redistribution layer, and then is proceeded to steps (b) and (c).
